(19) United States
(12) Patent Application Publication
(10) Pub. No.: US 2017/0118265 A1
(43) Pub. Date: Apr. 27, 2017

(54) METHOD, SERVER, CLIENT AND SYSTEM FOR REMOTELY CONTROLLING CUSTOMIZED CHANNELS

(71) Applicants: Le Holdings (Beijing) Co., Ltd., Beijing (CN); Le Shi Zhi Xin Electronic Technology (Tianjin) Limited, Tianjin (CN)

(72) Inventor: Hui Zhao, Tianjin (CN)

(73) Assignees: Le Holdings (Beijing) Co., Ltd., Beijing (CN); Le Shi Zhi Xin Electronic Technology (Tianjin) Limited, Tianjin (CN)

(21) Appl. No.: 15/240,576

(22) Filed: Aug. 18, 2016

Related U.S. Application Data
(63) Continuation of application No. PCT/CN2016/086616, filed on Jun. 21, 2016.

(30) Foreign Application Priority Data
Oct. 22, 2015 (CN) 201510694686.3

(51) Int. Cl. H04L 29/06; H04L 29/08

(52) U.S. Cl. CPC H04L 65/60; H04L 67/10; H04L 67/26

(57) ABSTRACT

Disclosed is a method for remotely controlling customized channels, including: receiving a data source of a customized channel uploaded by a client; conducting automatic collation regularly and excluding an unqualified data source; storing a qualified data source, and forming a customized channel source; receiving a download and/or play request raised by the client; and providing the customized channel source to the client for a user to download and/or play. The present invention also discloses a device for remotely controlling customized channels. According to the method and the device for remotely controlling customized channels provided by the present invention, the qualified customized channel source is provided to the user, a channel database is expanded, and the special needs of the user are satisfied.

### CROSS REFERENCE TO RELATED APPLICATIONS

This application is a continuation of International Application No. PCT/CN2016/086616, filed on Jun. 21, 2016, which is based upon and claims priority to Chinese Patent Application No. 201510694686.3, filed on Oct. 22, 2015, the entire contents of which are incorporated herein by reference.

### TECHNICAL FIELD

The disclosure relates to the technical field of remotely controlling customized channels, and more particularly, to a method, a server, a client and a device for remotely controlling customized channels.

### BACKGROUND

A full-video TV desktop, based on a live interface, is added with a customization function. The function is mainly convenient for a user to play a customized TV source. A method which is mainly used is:

The user stores customized live sources collected in a fixedly named file according to a certain format. When the full-video TV desktop is started, the customized live sources in the file may be directly imported into a memory, saved in a program file, and arranged in a customized channel area like other live channels for the user to select and switch.

However, it is found by the inventor during the process of research and development that partial program functions of these channels cannot be used since the channels are customized. Moreover, because the customized live sources are not screened effectively, the customized live sources cannot be collected, analyzed and utilized according to requirements, so that the special demands of the user cannot be satisfied.

### SUMMARY

Based on the foregoing problems, one embodiment of the present invention is to provide a method for remotely controlling customized channels, which effectively screens a data source of a customized channel through a server, thus providing a customized channel source to a client to take full advantage of the customized channel source, so that a channel database is expanded, and the special demands of a user are satisfied. Another embodiment of the present invention also provides a server, a client and a device for remotely controlling customized channels.

According to a first aspect, the present invention provides a method for remotely controlling customized channels, including: a step of receiving data source, including: receiving a data source of a customized channel uploaded by a client; a step of excluding unqualified data source, including: regularly performing automatic collation and excluding an unqualified data source; a step of storing data source, including: storing a qualified data source, and forming a customized channel source; a step of receiving a download and/or play request, including: receiving a download and/or play request raised by the client; and a step of providing customized channel source, including: providing the customized channel source to the client for a user to download and/or play.

According to a second aspect, the present invention also provides an electronic device, including a memory and at least one central processing unit, where the memory is connected to the at least on central processing unit by using a bus, the memory is configured to store a computer instruction, and when the device runs, the at least on central processing units executes the device to execute the following operations: receiving a data source of a customized channel uploaded by a client; conducting automatic collation regularly and excluding an unqualified data source; storing a qualified data source, and forming a customized channel source; receiving a download and/or play request raised by the client; and providing the customized channel source to the client for a user to download and/or play.

According to a third aspect, the present invention provides a non-volatile computer readable storage medium, where the non-volatile computer readable storage medium stores a computer instruction, and a computer executes the computer instruction to execute the following operations: receiving a data source of a customized channel uploaded by a client; conducting automatic collation regularly and excluding an unqualified data source; storing a qualified data source, and forming a customized channel source; receiving a download and/or play request raised by the client; and providing the customized channel source to the client for a user to download and/or play.

By employing the foregoing technical solution the following advantageous effects will be produced: the data source of the customized channel is provided to the server through the client, then the server screens the data source of the customized channel and stores the data source of the customized channel in the server for providing the customized channel source to the user, so that the channel database is expanded, and the special demands of the user are satisfied.

There have been more than one million full-video TV desktop users already, distributing in all provinces and municipalities throughout the country, and a high percentage of the users will use the customized channel source. This is a giant database, while collecting, analyzing and utilizing the database will greatly enrich channel resources, and satisfy the special demands of the user.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for remotely controlling customized channels applied on a server according to one embodiment of the present invention;

FIG. 2 is a flow chart of excluding an unqualified data source in a method for remotely controlling customized channels applied on a server according to another embodiment of the present invention;

FIG. 3 is a block diagram of storing a data source in a method for remotely controlling customized channels applied on a server according to another embodiment of the present invention;

FIG. 4 is a flow chart of a method for remotely controlling customized channels applied on a server according to another embodiment of the present invention;

FIG. 5 is a flow chart of a method for remotely controlling customized channels applied on a client according to one embodiment of the present invention;

FIG. 6 is a flow chart of a method for remotely controlling customized channels applied on a client according to another embodiment of the present invention;

FIG. 7 is a flow chart of a method for remotely controlling customized channels applied on a client according to another embodiment of the present invention;

FIG. 8 is a block diagram of a server for remotely controlling customized channels according to one embodiment of the present invention;

FIG. 9 is a block diagram of a module for excluding unqualified data sources in a server for remotely controlling customized channels according to another embodiment of the present invention;

FIG. 10 is a block diagram of a module for storing data sources in a server for remotely controlling customized channels according to another embodiment of the present invention;

FIG. 11 is a block diagram of a server for remotely controlling customized channels according to another embodiment of the present invention;

FIG. 12 is a block diagram of a client for remotely controlling customized channels according to one embodiment of the present invention;

FIG. 13 is a block diagram of a client for remotely controlling customized channels according to another embodiment of the present invention; and

FIG. 14 is a block diagram of a device for remotely controlling customized channels according to another embodiment of the present invention;

FIG. 15 is a hardware structure diagram of an electronic device for performing the method for remotely controlling customized channels according to one embodiment of the present disclosure.

### DETAILED DESCRIPTION

The specific embodiments of the present invention will be described clearly and completely hereinafter with reference to the accompanying figures. Apparently, the embodiments described are some, but not all embodiments of the present invention. Other embodiments derived by those having ordinary skills in the art on the basis of the embodiments of the invention without going through creative efforts shall all fall within the protection scope of the present invention. The technical features involved in different embodiments of the present invention described herein may be combined mutually as long as no conflictions are constituted there among.

Referring to FIG. 1, one embodiment of the present invention provides a method for remotely controlling customized channels, including: a step of receiving data source 101, including receiving a data source of a customized channel uploaded by a client; a step of excluding unqualified data source 102, including regularly conducting automatic collation and excluding an unqualified data source; a step of storing data source 103, including storing a qualified data source, and forming a customized channel source; a step of receiving download and/or play request 104, including receiving a download and/or play request raised by the client; and a step of providing customized channel source 105, including providing a customized channel source to the client for a user to download and/or play.

The method for remotely controlling customized channels provided by the embodiment is applied on a server, and the client may upload the data source of the customized channel acquired thereof or in a mobile storage device (USB disk, mobile hard disk) to the server. The data source may include format, domain name, website, or the like.

After receiving the data source of the customized channel, the server will screen the data source according to requirements, and exclude the unqualified data source. To be specific, automatic collation is conducted regularly and the unqualified data source is excluded according to a preset rule. The object of excluding the unqualified data source is to automatically exclude those source files that are nonstandard, sexually suggestive, terroristic, and other source files that break national laws, public order and moral, or the like, according to such data as format, domain name, website, etc. A step of excluding the unqualified data source will be introduced in details hereinafter.

Then, the qualified data source is stored to form a customized channel source, which expands a channel database on the server.

After receiving the download and/or play request raised by the client, the server provides the customized channel source to the client for the user to download and/or play. The customized channel source formed, such as a TV, will be pushed to the client finally. When the user opens the function at a terminal application, i.e., a full-video TV desktop, source files of all channels will be acquired from the server, and may be selected and added into a customized channel list for the user to view like a local customized channel.

In the present invention, the data source of the customized channel uploaded by the user is screened for multiple times by the server, so that the customized channel source satisfies various play requirements, and the source file downloaded by the client can be played smoothly. Moreover, the channel source database is expanded, and different demands of different users are satisfied.

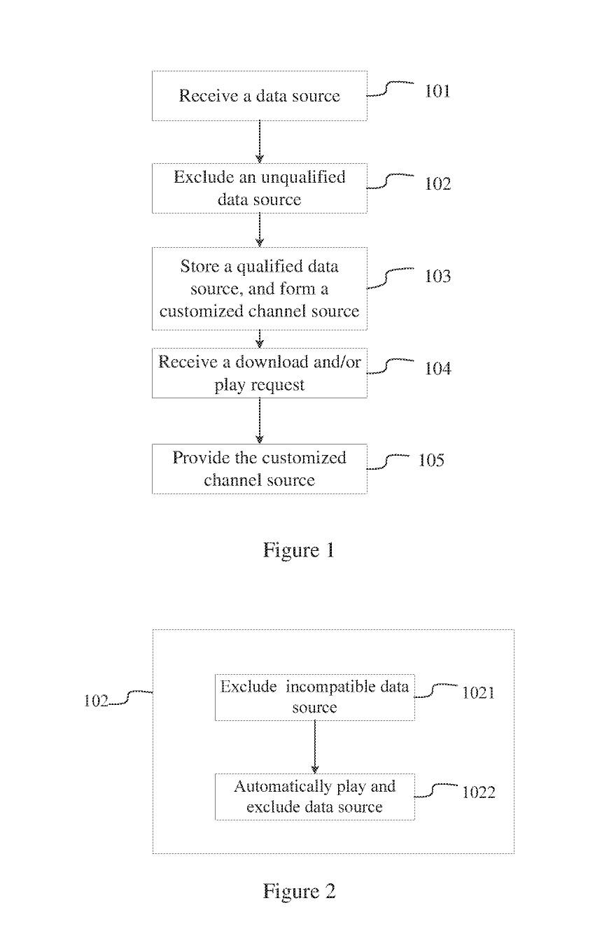

Referring to FIG. 2, in one embodiment of the present invention, the step of excluding the unqualified data source 102 further includes the following steps: a step of excluding incompatible data source 1021, including excluding a data source having incompatible file designation according to a format rule of a file name and excluding an illegal data source according to a denomination name of a file to obtain a compatible data source; a step of automatically playing and excluding data source 1022, including playing a compatible data source continuously in a loop, and excluding a data source that cannot be played to obtain the qualified data source.

Wherein, the step of excluding the data source having incompatible file designation according to the format rule of the file name refers to excluding the data source having a format that is nonstandard and does not comply with technical requirements of Android according to the format rule of the file name. The step of excluding the illegal data source according to the denomination name of the file refers to excluding those source files that are sexually suggestive, terroristic, and other source files that violate socialist ethics and break relevant national laws and regulations according to the denomination name. A denomination code or name table is compiled with reference to multiple sets of auditing codes in the industry and in combination with the code requirements of LETV. Those source files that are sexually suggestive, terroristic, relate to sensitive problems like religion and politics or the like, and those source files that break national laws and public order and moral or relate to competitors may be preliminarily excluded through the denomination code table.

Wherein, the step of automatically playing and excluding the data source refers to playing the compatible data source continuously in a loop, and excluding the data source that cannot be played by the server to obtain the qualified data source. After automatically playing the compatible data source continuously in a loop, the play of the qualified data source may be manually started to manually audit the qualified data source.

In the embodiment, the server is independently designed, wherein Aliyun and leadcloud servers are used. The server includes a server code and an android program. The server code includes an interface that receives a data source and a file uploaded by the client; after the data source collected is screened through the step of excluding the incompatible data source 1021, the compatible data source is uploaded to a storage unit of the server. The android program downloads the compatible data source file of the storage unit to play continuously in a loop (which may be combined with manual playing, and audited); after the compatible data source file is successfully played, the qualified data source is obtained, then the qualified data source is uploaded back to the storage unit for storage to form the customized channel source for the user to download.

In the embodiment of the present invention, the data source of the customized channel uploaded by the user is screened for multiple times by the server, so that the customized channel source satisfies various play requirements, and the source file downloaded by the client can be played smoothly.

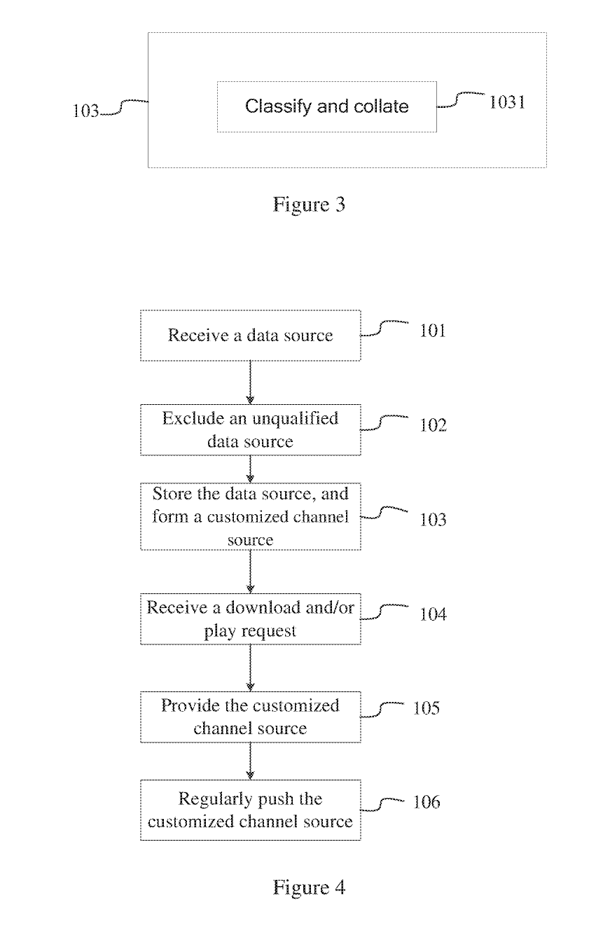

Referring to FIG. 3, in one embodiment, the step of storing the data source 103 further includes a step of classifying and collating 1031, which includes classifying, collating the customized channel source and then storing the customized channel source. The step of classifying and collating 1031 is configured to classify and collate the customized channel source into a sequence table to facilitate distinguishing and storing, so that the customized channel source can be read quickly.

Referring to FIG. 4, one embodiment also includes a step of regularly pushing customized channel sources 106, which includes regularly pushing the customized channel source stored to the client. The customized channel source stored and a channel source added for the server are regularly pushed to the client to update together. When the user opens the function at a terminal application, i.e., a full-video TV desktop, source files of all channels will be acquired from the server, and may be selected and added into a customized channel list for the user to view like a local customized channel Through the manner of regularly pushing, the user is enabled to view expected programs in time.

The step of regularly pushing the customized channel source 106 may occur in any time period after the step of storing the data source 103.

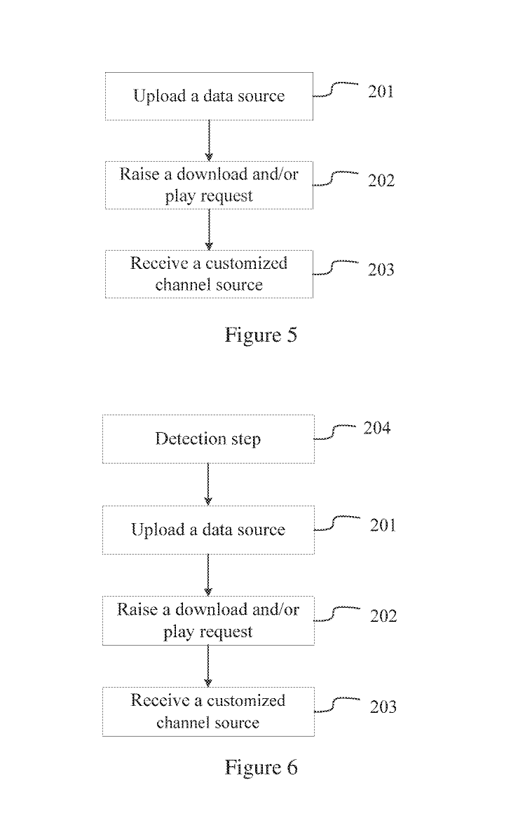

Referring to FIG. 5, one embodiment of the present invention provides a method for remotely controlling customized channels, including: a step of uploading data sources 201, including providing a data source of a customized channel to a server, wherein the server conducts automatic collation on the data source regularly and excludes an unqualified data source, and a customized channel source is formed after the qualified data source is stored; a step of raising download and/or play request 202, including raising a download and/or play request to the server; and a step of receiving customized channel source 203, including receiving the qualified and stored customized channel source screened by the server, and supplying the customized channel source to a user to download and/or play.

The method for remotely controlling customized channels provided by the embodiment is applied on a client (for example, a TV, a box, etc). The client may upload the data source of the customized channel acquired thereof or in a mobile storage device (USB disk, mobile hard disk) to the server. The data source may include format, domain name, website, or the like.

After receiving the data source of the customized channel, the server will screen the data source according to requirements, and exclude the unqualified data source. Then, the qualified data source is stored to form a customized channel source, which expands a channel database on the server.

When the user operators, the client raises a download and/or play request to the server, then the server provides the customized channel source to the client for the user to download and/or play. The customized channel source formed, such as a TV, will be pushed to the client finally. When the user opens the function at a terminal application, i.e., a full-video TV desktop, source files of all channels will be acquired from the server, and may be selected and added into a customized channel list for the user to view like a local customized channel.

In the present invention, the data source of the customized channel is provided to the server through the client, then the data source of the customized channel uploaded by the user is screened for multiple times by the server, so that the customized channel source obtained satisfies various play requirements, and the source file downloaded by the client can be played smoothly. Moreover, the channel source database is expanded, and different demands of different users are satisfied.

Referring to FIG. 6, before the step of uploading the data source 201, one embodiment further includes a detection step 204, including detecting whether a mobile storage device exists in a client; if the mobile storage device is detected, then detecting whether the data source of the customized channel exists in the mobile storage device; and if the data source of the customized channel is detected in mobile storage device, then performing a step of outputting data source 201 to upload the data source of the customized channel to the server. The mobile storage device may be such a storage device as a USB disk, a mobile hard disk, or the like, that facilitates the user to upload a customized channel data source according to the hobbies thereof, so that different demands are satisfied.

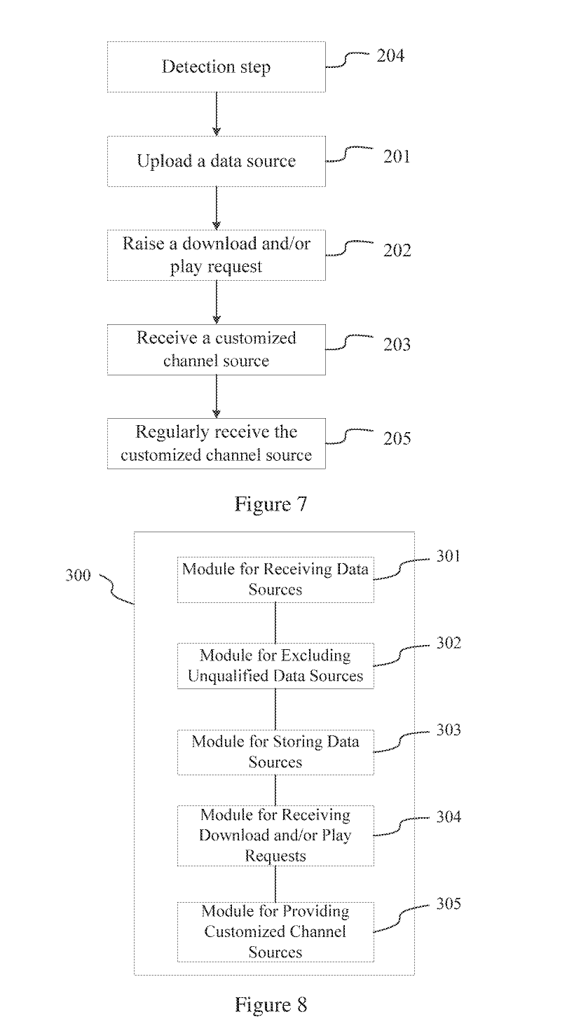

Referring to FIG. 7, one embodiment further includes a step of regularly receiving customized channel sources 205, including regularly receiving the customized channel source pushed by the server. The step of regularly receiving the customized channel source 205 may occur in any time period, and is configured to receive the customized channel source pushed regularly by the server and a channel source added for the server and provided together with the customized channel source to implement regular updating. Through the manner of regularly pushing, the user is enabled to view expected programs in time.

Referring to FIG. 8, one embodiment of the present invention provides a server for remotely controlling customized channels 300, including: a module for receiving data sources 301, configured to receive a data source of a customized channel uploaded by a client; a module for excluding unqualified data sources 302, configured to conduct automatic collation regularly and exclude an unqualified data source; a module for storing data sources 303 configured to store a qualified data source, and form a customized channel source; a module for receiving download and/or play requests 304, configured to receive a download and/or play request raised by the client; and a module for providing customized channel sources 305, configured to provide the customized channel source to the client for a user to download and/or play.

The client may upload the data source of the customized channel acquired by the client or in a mobile storage device (USB disk, mobile hard disk). The data source may include format, domain name, website, or the like. The module for receiving data sources 301 is configured to receive the data source of the customized channel above.

The server 300 after receiving the data source of the customized channel, will screen the data source according to requirements, and exclude the unqualified data source through the module for excluding unqualified data sources 302. To be specific, automatic collation is conducted regularly and the unqualified data source is excluded according to a preset rule. The object of excluding the unqualified data source is to automatically exclude those source files that are nonstandard, sexually suggestive, terroristic, and other source files that break national laws, public order and moral, or the like, according to such data as format, domain name, website, etc. A step of excluding the unqualified data source will be introduced in details hereinafter.

Then, the qualified data source is stored in the module for storing data sources 303 to form a customized channel source, which expands a channel database on the server.

After the module for receiving download and/or play requests 304 receives the download and/or play request raised by the client, the server 300 provides the customized channel source to the client for the user to download and/or play through the module for providing customized channel sources 305. The customized channel source formed, such as a TV, will be pushed to the client finally. When the user opens the function at a terminal application, i.e., a full-video TV desktop, source files of all channels will be acquired from the server, and may be selected and added into a customized channel list for the user to view like a local customized channel.

In the present invention, the data source of the customized channel uploaded by the user is screened for multiple times by the server, so that the customized channel source satisfies various play requirements, and the source file downloaded by the client can be played smoothly. Moreover, the channel source database is expanded, and different demands of different users are satisfied.

Referring to FIG. 9, in one embodiment, the module for excluding unqualified data sources 302 further includes: a module for excluding incompatible data sources 3021, configured to exclude a data source having incompatible file designation according to a format rule of a file name and exclude an illegal data source according to a denomination name of a file to obtain a compatible data source; and a module for automatically playing and excluding data sources 3022, configured to play a compatible data source continuously in a loop, and exclude a data source that cannot be played to obtain the qualified data source.

The module for excluding incompatible data sources 3021 excludes an incompatible data source according to a format rule of a file name and a denomination name of a file to obtain a compatible data source.

Wherein, the step of excluding the data source having incompatible file designation according to the format rule of the file name refers to excluding the data source having a format that is nonstandard and does not comply with technical requirements of Android according to the format rule of the file name. The step of excluding the illegal data source according to the denomination name of the file refers to excluding those source files that are sexually suggestive, terroristic, and other source files that violate socialist ethics and break relevant national laws and regulations according to the denomination name. A denomination code or name table is compiled with reference to multiple sets of auditing codes in the industry and in combination with the code requirements of LETV. Those source files that are sexually suggestive, terroristic, relate to sensitive problems like religion and politics or the like, and those source files that break national laws and public order and moral or relate to competitors may be preliminarily excluded through the denomination code table.

Wherein, the module for automatically playing and excluding data sources 3022 automatically plays the compatible data source continuously in a loop through the server, and excludes the data source that cannot be played by the server to obtain the qualified data source. After playing the compatible data source continuously in a loop, the play of the qualified data source may be manually started to manually audit the qualified data source.

In the embodiment, the server 300 is independently designed, wherein Aliyun and leadcloud servers are used. The server includes a server code and an android program. The server code includes an interface that receives a data source and a file uploaded by the client; after the data source collected is screened through the module for excluding incompatible data sources 3021, the compatible data source is uploaded to a storage unit of the server. The android program downloads the compatible data source file of the storage unit to play continuously in a loop (which may be combined with manual playing, and audited); after the compatible data source file is successfully played, the qualified data source is obtained, then the qualified data source is uploaded back to the storage unit for storage to form the customized channel source for the user to download.

In the embodiment of the present invention, the data source of the customized channel uploaded by the user is screened for multiple times by the server, so that the customized channel source satisfies various play requirements, and the source file downloaded by the client can be played smoothly.

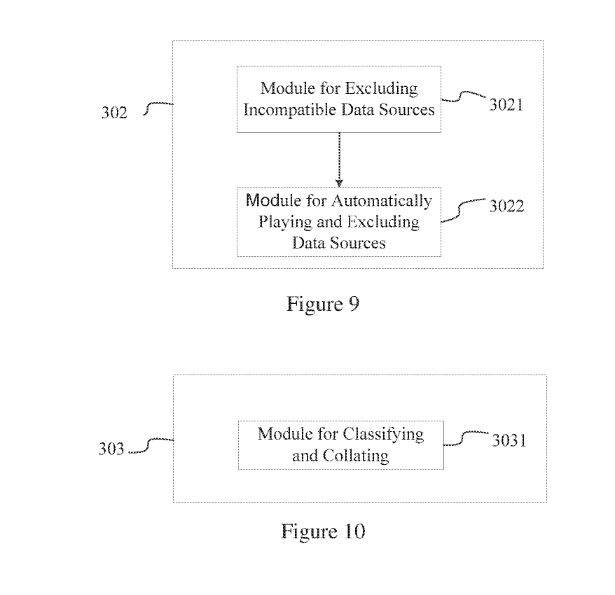

Referring to FIG. 10, in one embodiment, the module for storing data sources 303 further includes a module for classifying and collating 3031 configured to classify and collate the customized channel source, and then store the customized channel source. The module for classifying and collating 3031 is configured to classify and collate the customized channel source into a sequence table to facilitate distinguishing and storing, so that the customized channel source can be read quickly.

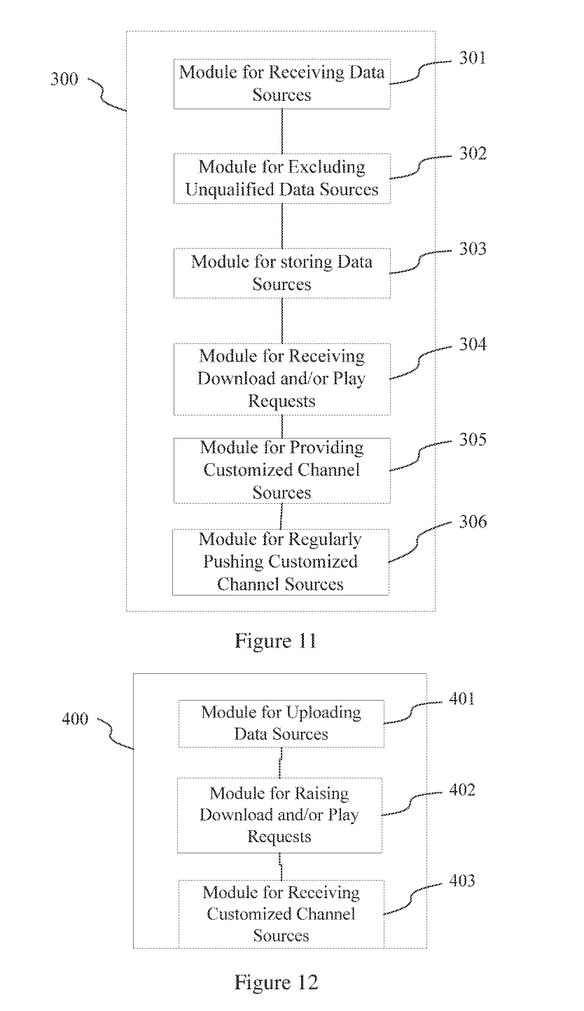

Referring to FIG. 11, one embodiment further includes a module for regularly pushing customized channel sources 306 configured to regularly push the customized channel source stored to the client. The customized channel source stored and a channel source added for the server are regularly pushed to the client to update together. When the user opens the function at a terminal application, i.e., a full-video TV desktop, source files of all channels will be acquired from the server, and may be selected and added into a customized channel list for the user to view like a local customized channel Through the manner of regularly pushing, the user is enabled to view expected programs in time.

Referring to FIG. 12, one embodiment of the present invention provides a client for remotely controlling customized channels 400, including: a module for uploading data sources 401 configured to provide a data source of a customized channel to a server, wherein the server conducts automatic collation on the data source regularly and excludes an unqualified data source, and a customized channel source is formed after the qualified data source is stored; a module for raising download and/or play requests 402, configured to raise a download and/or play request to the server; and a module for receiving customized channel sources 403, configured to receive the qualified and stored customized channel source screened by the server, and supply the customized channel source to a user to download and/or play.

The client 400 may upload the data source of the customized channel acquired by the client or in a mobile storage device (USB disk, mobile hard disk) to the server through the module for uploading data sources 401. The data source may include format, domain name, website, or the like.

After receiving the data source of the customized channel, the server will screen the data source according to requirements, and exclude the unqualified data source. Then, the qualified data source is stored to form a customized channel source, which expands a channel database on the server.

When the user operates, the client 400 raises a download and/or play request to the server through the module for raising download and/or play requests 402, then the server provides the customized channel source to the client, and the client 400 receives the foregoing customized channel source through the module for receiving customized channel sources 403 for the user to download and/or play. The customized channel source formed, such as a TV, will be pushed to the client finally. When the user opens the function at a terminal application, i.e., a full-video TV desktop, source files of all channels will be acquired from the server, and may be selected and added into a customized channel list for the user to view like a local customized channel.

In the present invention, the data source of the customized channel is provided to the server through the client, then the data source of the customized channel uploaded by the user is screened for multiple times by the server, so that the customized channel source obtained satisfies various play requirements, and it is ensured that the source file downloaded by the client can be played smoothly. Moreover, the channel source database is expanded, and different demands of different users are satisfied.

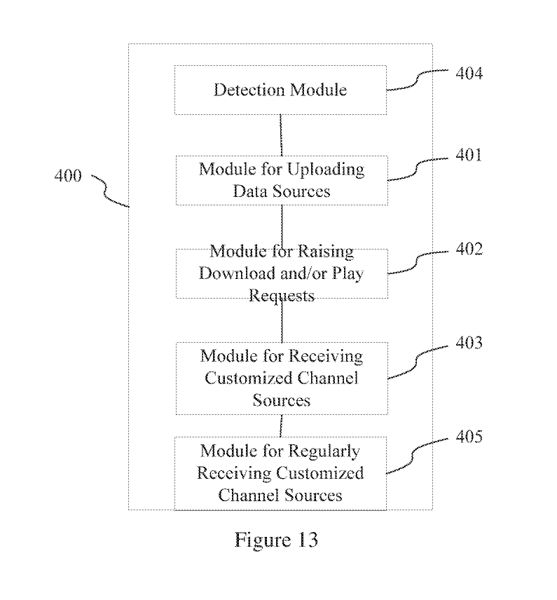

Referring to FIG. 13, one embodiment further includes a detection module 404 configured to detect whether a mobile storage device exists in a client; if the mobile storage device is detected, then detect whether the data source of the customized channel exists in the mobile storage device; and if the data source of the customized channel is detected in mobile storage device, then perform a step of outputting data source to upload the data source of the customized channel to the server. The mobile storage device may be such a storage device as a USB disk, a mobile hard disk, or the like, that facilitates the user to upload a customized channel data source according to the hobbies thereof, so that different demands are satisfied.

Referring to FIG. 13, one embodiment further includes a module for regularly receiving customized channel sources 405 configured to regularly receive a customized channel source pushed by the server. The module for regularly receiving customized channel sources 405 is configured to receive the customized channel source regularly pushed by the server and a channel source added for the server and provided together with the customized channel source to implement regular updating. Through the manner of regularly pushing, the user is enabled to view expected programs in time.

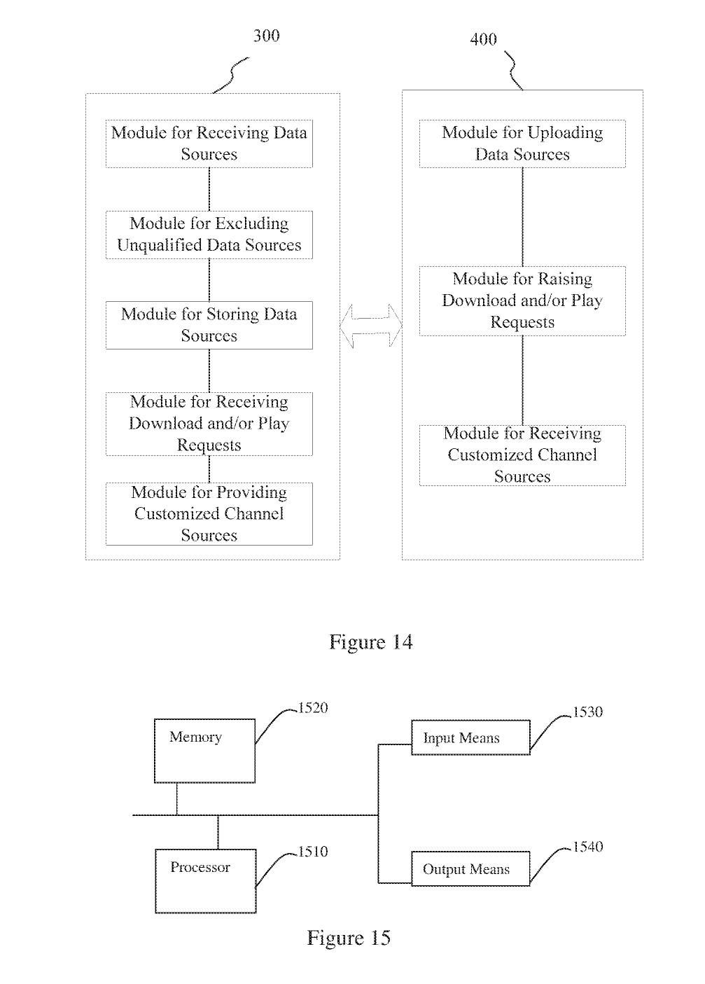

Referring to FIG. 14, one embodiment of the present invention provides a device for remotely controlling customized channels, including a server 300 and a client 400.

Wherein, the server includes: a module for receiving data sources, configured to receive a data source of a customized channel uploaded by the client; a module for excluding unqualified data sources, configured to conduct automatic collation regularly and exclude an unqualified data source; a module for storing data sources, configured to store a qualified data source, and form a customized channel source; a module for receiving download and/or play requests, configured to receive a download and/or play request raised by the client; and a module for providing customized channel sources, configured to provide the customized channel source to the client for a user to download and/or play; and the client includes: a module for uploading data sources, configured to provide a data source of a customized channel to the server; a module for raising download and/or play requests, configured to raise a download and/or play request to the server; and a module for receiving customized channel sources, configured to receive the qualified and stored customized channel source screened by the server, and supply the customized channel source to a user to download and/or play.

In the present invention, the data source of the customized channel is provided to the server through the client, then the data source of the customized channel uploaded by the user is screened for multiple times by the server, so that the customized channel source obtained satisfies various play requirements, and it is ensured that the source file downloaded by the client can be played smoothly. Moreover, the channel source database is expanded, and different demands of different users are satisfied.

It may be understood by those having ordinary skills in the art that the all or part flows of implementing the methods in the foregoing embodiments may be finished through relevant hardware instructed by a computer program. The program may be stored in a mobile device or a computer readable storage medium, and the program while performing includes one or a combination of the flows of the embodiments according to the methods above. Based on such understanding, the foregoing technical solutions essentially, or the part contributing to the prior art, or the part of the technical solution may be implemented in the form of a software product. The computer software product may be stored in a storage medium, and includes several instructions for instructing a mobile terminal (which may be a personal computer, a server, or a network device, a mobile phone so on) to execute the all or a part of steps of the method according to each embodiment of the present invention. While the forementioned storage medium includes: any medium that is capable of storing program codes, such as a USB disk, a mobile hard disk, a read-only memory (ROM, Read-Only Memory), a random access memory (RAM, Random Access Memory), a magnetic disk, or an optical disk.

One embodiment of the present disclosure provides a nonvolatile computer-readable storage medium which stores executable instructions, wherein the method for remotely controlling customized channels according to any one embodiment as above can be performed by the executable instructions.

FIG. 15 is a hardware structure diagram of an electronic device for performing the method for remotely controlling customized channels according to one embodiment of the present disclosure.

As shown in FIG. 15, the electronic device includes one or more processors 1510 and a memory 1520. FIG. 15 takes one processor 1510 as an example.

The electronic device for performing the method for remotely controlling customized channels may further include an input means 1530 and an output means 1540.

The processor 1510, the memory 1520, the input means 1530 and the output means 1540 may be connected via a bus or in other ways. In FIG. 15, these elements are connected via a bus.

The memory 1520 can be used as a nonvolatile computer-readable storage medium, which can store a nonvolatile software program, a nonvolatile computer-executable program, and respective modules. For example, the medium stores program instructions/modules for performing the method for remotely controlling customized channels according to the embodiments of the present disclosure, such as the module for receiving data sources, the module for excluding unqualified data sources, the module for storing data sources, the module for receiving download and/or play requests, the module for providing customized channel sources, the module for uploading data sources, the module for raising download and/or play requests, and the module for receiving customized channel sources. The processor 1510 executes the nonvolatile software program, instructions and/or modules stored within the memory 1520, so as to perform several functional applications and data processing, particularly, realize the method for remotely controlling customized channels according to the above embodiments as above.

The memory 1520 may include a storage program zone and a storage data zone. The storage program zone may store an operating system and at least one application program for achieving respective functions. The storage data zone may store data created according to the usage of the device for remotely controlling customized channels. In addition, the memory 1520 may further include a high speed random access memory and a nonvolatile memory, e.g. at least one of a disk storage device, a flash memory or other nonvolatile solid storage device. In some embodiments, the memory 1520 may include a remote memory remotely located relative to the processor 1510, and this remote memory may be connected, via a network, to the device for remotely controlling customized channels. For example, the network includes but is not limited within internet, intranet, local area network, mobile communication network and any combination thereof.

The input means 1530 can receive digital or character information inputted, and generate a signal input associated with a user setting and a functional controlling of the device for remotely controlling customized channels. The output means 1540 may include a display device such as a displaying screen.

One or more storage modules are stored within the memory 1520. When said one or more storage modules are operated by one or more processors 1510, the method for remotely controlling customized channels of the above embodiments is performed.

The products as above-mentioned may perform methods provided by the embodiments of the present disclosure, have functional modules for performing the methods, and achieve respective beneficial effects. For those technical details which are not mentioned in this embodiment, please refer to the methods provided by the embodiments of the disclosure.

The electronic device of the embodiment of the present disclosure may be constructed in several forms, which include but are not limited within:

(1) mobile communication device: this type of terminal has a function of mobile communication for main propose of providing a voice/data communication. This type of terminal includes: a smartphone (e.g. iPhone), a multimedia mobile phone, a feature phone, a low-end cellphone and so on;

(2) ultra mobile personal computer device: this type of terminal belongs to a personal computer which has a computing function and a processing function. In general, this type of terminal has a networking characteristic. This type of terminal includes: PDA, MID, UMPC and the like, e.g. iPad;

(3) portable entertainment device: this type of device can display and play multimedia contents. This type of device includes an audio/video player (e.g. iPod), a handheld game console, an electronic book, an intelligent toy, and a portable vehicle navigation device;

(4) server: the server provides a computing service. The construction of a server includes a processor, a hard disk, an internal memory, a system bus and so on, which is similar to the construction of a general computer but can provide more reliable service. Therefore, with respect to processing ability, stability, reliability, security, extendibility and manageability, a server has to meet a higher requirement; and

(5) other electronic devices having data interchanging functions.

The above embodiments are for purposes of illustration and description to the technical solution of the present invention merely, but are not intended to limit the present invention. Although the embodiments of the present invention has been illustrated in detail according to the foregoing embodiments, those having ordinary skills in the art should understand that modifications can still be made to the technical solutions recited in various embodiments described above, or equivalent substitutions can still be made to a part of technical features thereof, and these modifications or substitutions will not make the essence of the corresponding technical solutions depart from the spirit and scope of the claims.

What is claimed is:

1. A method for remotely controlling customized channels, applied at an electronic device, comprising:
receiving a data source of a customized channel uploaded by a client;
conducting automatic collation regularly and excluding an unqualified data source;
storing a qualified data source, and forming a customized channel source;
receiving a download and/or play request raised by the client; and
providing the customized channel source to the client for a user to download and/or play.

2. The method for remotely controlling customized channels according to claim 1, wherein the step of conducting automatic collation regularly and excluding the unqualified data source further comprises the following steps:
excluding a data source having incompatible file designation according to a format rule of a file name and excluding an illegal data source according to a denomination name of a file to obtain a compatible data source; and
playing the compatible data source continuously in a loop, and excluding a data source that cannot be played to obtain the qualified data source.

3. The method for remotely controlling customized channels according to claim 1, wherein the step of storing the qualified data source and forming the customized channel source further comprises: classifying and collating the customized channel source, and then storing the customized channel source.

4. The method for remotely controlling customized channels according to claim 1, further comprising: regularly pushing the customized channel source stored to the client.

5. A device for remotely controlling customized channels, comprising:
at least one processor; and
a memory communicably connected with the at least one processor for storing instructions executable by the at least one processor, wherein execution of the instructions by the at least one processor causes the at least one processor to:
receive a data source of a customized channel uploaded by a client;
conduct automatic collation regularly and exclude an unqualified data source;
store a qualified data source, and form a customized channel source;
receive a download and/or play request raised by the client; and
provide the customized channel source to the client for a user to download and/or play.

6. The device for remotely controlling customized channels according to claim 5, wherein the step of conducting automatic collation regularly and excluding the unqualified data source further comprises the following steps:
excluding a data source having incompatible file designation according to a format rule of a file name and excluding an illegal data source according to a denomination name of a file to obtain a compatible data source; and
playing the compatible data source continuously in a loop, and excluding a data source that cannot be played to obtain the qualified data source.

7. The device for remotely controlling customized channels according to claim 5, wherein the step of storing the qualified data source and forming the customized channel source further comprises: classifying and collating the customized channel source, and then storing the customized channel source.

8. The device for remotely controlling customized channels according to claim 5, further comprising: regularly pushing the customized channel source stored to the client.

9. A non-transitory computer-readable storage medium storing executable instructions that, when executed by an electronic device with a touch-sensitive display, cause the electronic device to:
receive a data source of a customized channel uploaded by a client;
conduct automatic collation regularly and exclude an unqualified data source;
store a qualified data source, and form a customized channel source;
receive a download and/or play request raised by the client; and
provide the customized channel source to the client for a user to download and/or play.

10. The non-transitory computer-readable storage medium according to claim 9, wherein the step of conducting automatic collation regularly and excluding the unqualified data source, performed by the computer executable instructions, further comprises the following steps:
excluding a data source having incompatible file designation according to a format rule of a file name and excluding an illegal data source according to a denomination name of a file to obtain a compatible data source; and
playing the compatible data source continuously in a loop, and excluding a data source that cannot be played to obtain the qualified data source.

11. The non-transitory computer-readable storage medium according to claim 9, wherein the step of storing the qualified data source and forming the customized channel source, performed by the computer executable instructions, further comprises: classifying and collating the customized channel source, and then storing the customized channel source.

12. The non-transitory computer-readable storage medium according to claim 9, wherein the computer executable instructions are also adapted to perform: regularly pushing the customized channel source stored to the client.
